(19) United States
(12) Patent Application Publication
(10) Pub. No.: US 2010/0121753 A1
(43) Pub. Date: May 13, 2010

(54) SYSTEM AND METHOD FOR HOSTING A PLURALITY OF TRADING ALGORITHMS ON AN EXCHANGE

(76) Inventors: David Harris, Ridgewood, NJ (US); William Harts, New York, NY (US)

Correspondence Address: BRINKS HOFER GILSON & LIONE, P.O. BOX 10395, CHICAGO, IL, 60610, US

(21) Appl. No.: 12/482,204

(22) Filed: Jun. 10, 2009

Related U.S. Application Data
(60) Provisional application No. 61/060,769, filed on Jun. 11, 2008.

(51) Int. Cl. G06Q 40/00

(52) U.S. Cl. 705/37

(57) ABSTRACT

A system and method of hosting a plurality of trading algorithms on an exchange is provided. The method includes an exchange server that receives an algorithm for trading orders from a user and associates the algorithm with the user in a database. The exchange server receives a marked order having information for associating the marked order with the algorithm, selects the algorithm associated with the user, receives market data from a market data feed, and executes the marked order according to the selected algorithm and the market data. The system includes an exchange server, rule container and rule database configured to execute the above-noted method.

### CROSS-REFERENCE TO RELATED APPLICATIONS

This application claims the benefit of U.S. Provisional Application No. 61/060,769, filed Jun. 11, 2008, the entirety of which is incorporated herein by reference.

### TECHNICAL FIELD

The present disclosure relates to methods and systems for utilizing existing infrastructure of exchanges to offer algorithmic hosting services to broker-dealers to avoid the overhead of developing, implementing, and maintaining an infrastructure to support algorithms for use in the algorithmic trading of financial instruments.

### BACKGROUND

Presently, broker-dealers use algorithmic trading to efficiently execute large numbers of trades without requiring the addition of expensive traders. Aggregating orders within algorithms allows brokers to internalize their trade flow and realize additional savings per share executed. Brokers are also selling these algorithms to their buy-side clients as a way for them to increase profits and realize consistent trading costs.

Although trading algorithms offer the promise of cost savings and scalability, they are, in practice, very expensive to develop, implement, and maintain. In terms of infrastructure, they require the use of dozens of servers each housed in a state-of-the-art data center. High-speed market data and its attendant infrastructure must be purchased. A large technical staff is necessary to maintain the infrastructure. Additionally, a research staff is necessary to develop the algorithms and a programming staff is required to implement them.

The high cost of implementing this technology has meant that only the top tier of broker dealers has been able to enter the algorithmic trading marketplace. Mid-size and smaller brokers simply cannot justify the initial investment or the recurring charges to make algorithmic trading feasible. Even the top tier broker dealers are looking for ways to reduce the costs of their algorithmic trading efforts.

### SUMMARY

In order to address at least one of the drawbacks of current algorithmic trading environments, a method and system to provide a hosted platform for brokers to access trading algorithms maintained by an exchange is disclosed.

According to one aspect, a method of accessing one of a plurality of algorithms stored in a system connected to an exchange is disclosed. The method includes an exchange server receiving from a user of the exchange an algorithm for trading orders and associating the algorithm with the user in a database that is in communication with the exchange server, where the database is configured to receive and store user supplied algorithms. The method also may include the exchange server receiving a marked order, the marked order marked with information for associating the marked order with the algorithm, selecting the algorithm associated with the user, receiving market data from a market data feed, and executing the marked order according to the selected algorithm and the market data.

In accordance with another aspect, an exchange system for accessing at least one algorithm by a user for executing a trade on an exchange is disclosed. The exchange system may include a rule container having a rule database for storing the at least one algorithm, where the rule container is configured to receive and store pre-programmed and user-supplied algorithms and where the rule container is operatively connected with an exchange server of the exchange system. The exchange system may also include a rule agent representative of the at least one algorithm and assigned to the user, where the assigned rule agent is selectable by the rule container. Additionally, a market data feed may be operatively engaged to the rule agent, wher the market data feed provides market data for use in the execution of a marked order according to the at least one algorithm. The exchange system is configured to receive marked orders at the exchange server, identify an appropriate rule agent in the rule container for each marked order based on information in the marked order, transmit marked orders to the rule container for trade execution by the exchange server using the appropriate rule agent, and the rule container is configured to transmit trades to the exchange server in communication with the rule container for trade execution.

### BRIEF DESCRIPTION OF THE DRAWINGS

FIG. 1 illustrates a mapping of existing exchange hardware and software infrastructure to product and service offerings.

FIG. 2 is a graphical representation of an embodiment that includes order flow through a hosted algorithm on an exchange such as the CBOE Stock Exchange (CBSX).

### DETAILED DESCRIPTION

In the remote hosting arrangement of the present invention, at least one algorithm exists on a server that is separate from the broker-dealer systems. The difficulties of building an infrastructure, as well as managing and maintaining a large technical staff, are outsourced. Through the method and system of the present invention, any broker can offer algorithmic trading for its clients or use it internally and pay for the algorithms on an as-used or subscription basis. Such an arrangement “levels the playing field” between large brokers who have made the commitment to support the necessary infrastructure and smaller brokers who do not have the resources to do so.

The method and system disclosed herein provide an ideal solution for brokers to use a third party to remotely host the brokers' own (i.e., internally developed) algorithms or to use those provided “off-the-shelf” by an embodiment of the present invention. For example, an exchange such as the CBOE Stock Exchange (“CBSX”) has much of the required infrastructure in place, including but not limited to a data center with redundancy, market data feeds, and connectivity to all other exchanges and major sources of liquidity. An exchange such as CBSX can extend this infrastructure by hosting trading algorithms in its data center.

The benefits to an exchange are numerous, and include:
1. Providing a differentiated product that will increase order flow on an exchange.
2. Providing a value added product for which an exchange can charge a premium over its standard pricing.
3. Subject to best execution requirements, when an algorithm seeks to provide liquidity it will primarily post orders on the exchange.
4. Subject to best execution requirements, when an algorithm seeks to remove liquidity, the exchange will have the first opportunity to execute the trade if it is at the National Best Bid or Offer (“NBBO”).
5. By providing algorithms to clients, the exchange will become incorporated into a client's trading workflow. Not only is there a reason for the client to send order flow to the exchange, but also moving order flow away from the exchange would require additional work. This fact is a key differentiator for the exchange in a world where each market center is in either a race to provide faster order execution, or is trying to be the low-cost provider by manipulating pricing schemes.

Although algorithms have thus far been most popular in equities, other asset classes such as options and futures are experiencing increased demand for algorithmic trading.

### Products and Services

Product

A customer will be able to:
1. Use one of a plurality of pre-programmed algorithms;
2. Design and program its own set of trading algorithms using a provided framework; and/or
3. Host a previously built infrastructure at the exchange. Such an arrangement may be appealing to a broker who has made a platform investment but now wishes to reduce its recurring expense.

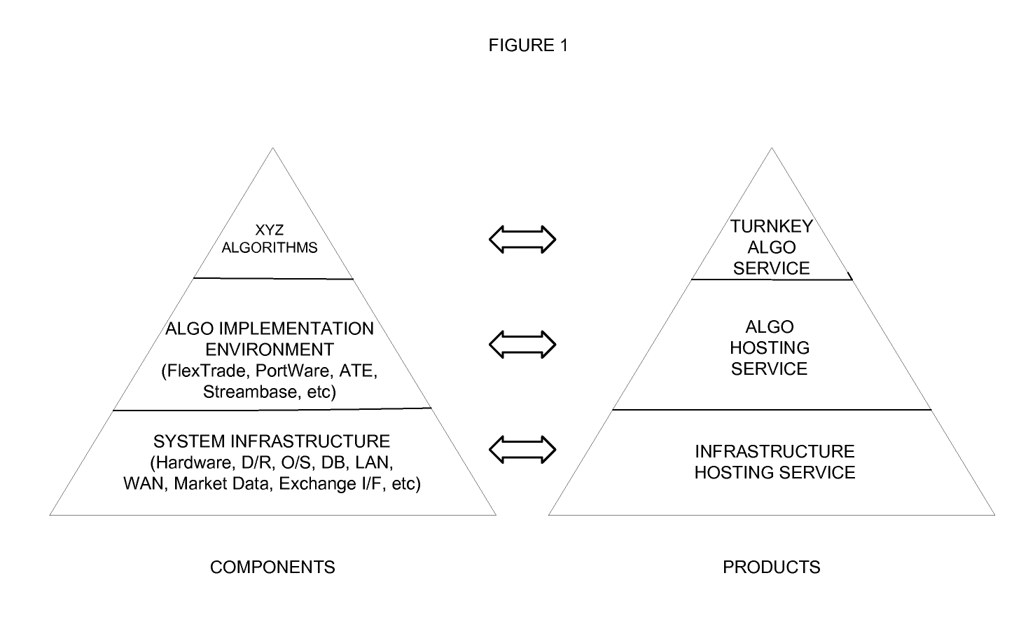

FIG. 1 illustrates a mapping of the infrastructure to product and service offerings.

Clients will therefore be able to use algorithms pursuant to particular skill levels and willingness to invest in algorithm development. There is no need to hire significant research and programming staff. Nor is there any longer a need to maintain an expensive infrastructure. Instead, the infrastructure of a third party, such as an existing exchange with its available computer processing capacity, database capabilities and communication interfaces, may be utilized. In an embodiment, every attempt will be made to make it appear to clients that the algorithm is being executed on the member-firm's own platform.

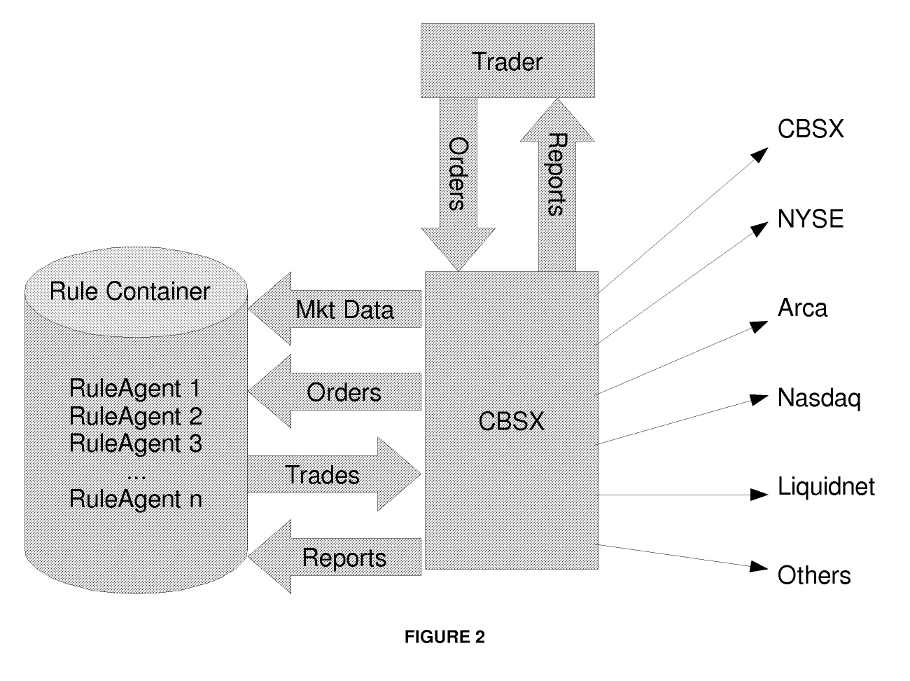

FIG. 2 is a graphical representation of an embodiment that includes order flow through a hosted algorithm on an exchange (CBSX).

Rule Containers are database collections of unique instances of a client's algorithms. Each unique instance of an algorithm is called a Rule Agent.
1. A trader enters an order and directs it to CBSX specifying the algorithm he wishes to use.
2. CBSX receives the order and sends it to the Rule Container, which implements the appropriate rule agent.
   a. A broker who develops its own algorithms will have its own Rule Container.
   b. Rule Agents are specific to each broker.
3. In the case where a client uses a pre-programmed rule, each broker will run a unique instance of the rule.
4. The Rule Agent receives market data from CBSX's market data feed. As appropriate it executes trades and uses CBSX's connectivity to access various liquidity providers.
   a. The Rule Container will provide order aggregation and crossing within a given client.
   b. Clients will be able to cancel unexecuted shares of an order.
   c. Subject to best execution requirements, CBSX will be the first choice to post liquidity if the algorithm is providing liquidity.
   d. Subject to best execution requirements, if the algorithm is removing liquidity and CBSX is at the NBBO, CBSX will have the first opportunity to interact with the order before it is routed away.
5. The order is executed by one of the market centers.
6. A report is sent back to CBSX. CBSX notifies the rule agent and the broker.

Real-time status information will be continuously transmitted back to the client throughout the lifetime of the order. A complete post trade reporting is preferably provided to brokers on a daily basis.

### Customers

Primary customers are broker-dealers needing access to trading algorithms but who do not want to incur the overhead of designing, building, maintaining and supporting the required infrastructure. These brokers would typically use these algorithms as a product offering to clients as well as for their own internal trading desks.

Buy-side customers who use sponsored access products to trade for themselves are also potential customers. These clients may have an algorithm they wish to use, but do not have the resources to implement. A hosted environment will make implementation economically feasible for them.

In all cases, orders directed to the system must originate from a broker who is a member of the hosting exchange.

### Competition

Competition may come from broker dealers. Broker dealers that have already made the investment in an algorithmic infrastructure may not want to host remotely. Some brokers may want to build their own infrastructure as a means of differentiation, control, or simply to justify the hiring of additional employees. These brokers may view the systems and methods described herein as a competitive threat since new entrants will be able to compete with them at a much lower cost. However, even these brokers and their clients may perceive a benefit to housing their algorithms within the well-regulated neutral environment of an exchange. In such an environment there is no concern about information leakage between client and proprietary order flow.

Certain large brokers, who have invested in an algorithmic infrastructure offer a “white-label” service whereby they accept order flow from other brokers who pay for the privilege of sending their agency orders to the white-label broker's algorithms.

### Operational Plan

Servers that run algorithms and process market data will be housed in an exchange's data center and will take advantage of the exchange's existing infrastructure and redundancy arrangements.

The system will receive orders directly from the exchange. As such, it can only receive orders from clients who have connectivity to the exchange through either their prime broker or other sponsoring broker dealer. A FIX message tag will be used to “mark” the order in order to notify the exchange that the order is destined for an algorithm housed in the system. This tag will be passed to the system so that the correct algorithm is executed.

The system will provide an application programming interface (API) to clients so that they can develop their own algorithms. Clients will have a secure method of accessing and altering their algorithms. The system will incorporate safeguards into the API and will perform quality control on client algorithms, including but not limited to the validity of messages sent from clients, checks of pre-defined trading limits, and compliance with industry regulations. The system may verify client algorithms at the request of the client.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method of accessing one of a plurality of algorithms stored in a system connected to an exchange, the method comprising the steps of an exchange server:
receiving from a user of the exchange an algorithm for trading orders;
associating the algorithm with the user in a database in communication with the exchange server, the database configured to receive and store user supplied algorithms;
receiving a marked order, the marked order marked with information for associating the marked order with the algorithm;
selecting the algorithm associated with the user;
receiving market data from a market data feed; and
executing the marked order according to the selected algorithm and the market data.

2. The method according to claim 1, wherein each user supplied algorithm is uniquely associated with each user.

3. The method according to claim 1, wherein the marked order is aggregated and crossed with other marked orders received from the user.

4. The method according to claim 1, further comprising the steps of the exchange server receiving cancellation instructions for an unexecuted portion of the marked order and canceling the unexecuted portion of the marked order.

5. The method according to claim 1, further comprising the step of interacting with the marked order prior to routing the marked order to another exchange.

6. The method of claim 1, wherein the marked order comprises information for associating the marked order with the user.

7. An exchange system for accessing at least one algorithm by a user for executing a trade on an exchange, comprising:
a rule container comprising a rule database for storing the at least one algorithm, the rule container configured to receive and store pre-programmed and user-supplied algorithms, wherein the rule container is operatively connected with an exchange server of the exchange system;
a rule agent representative of the at least one algorithm and assigned to the user, wherein the assigned rule agent is selectable by the rule container;
a market data feed operatively engaged to the rule agent, the market data feed providing market data for use in the execution of a marked order according to the at least one algorithm; and
wherein the exchange system is configured to receive marked orders at the exchange server, identify an appropriate rule agent in the rule container for each marked order based on information in the marked order, transmit marked orders to the rule container for trade execution by the exchange server using the appropriate rule agent, and wherein the rule container is configured to transmit trades to the exchange server in communication with the rule container for trade execution.

8. The exchange system according to claim 7, wherein each user supplied algorithm is uniquely associated with each user.

9. The exchange system according to claim 7, wherein the exchange server of the exchange system is configured to aggregate and cross a marked order from a user with other marked orders received from the user.

10. The exchange system according to claim 7, wherein the exchange server is further configured to receive cancellation instructions for an unexecuted portion of a marked order and cancel the unexecuted portion of the marked order.

11. The exchange system according to claim 7, wherein the exchange server is configured to permit the exchange to interact with the marked order prior to routing the marked order to another exchange.
